(19) United States
(12) Patent Application Publication
(10) Pub. No.: US 2011/0242952 A1
(43) Pub. Date: Oct. 6, 2011

(54) SIGNAL CONVERSION CIRCUIT AND SAMPLING METHOD THEREFOR

(75) Inventor: Hiromasa ISHIWATA, Kanagawa (JP)

(73) Assignee: Renesas Electronics Corporation

(21) Appl. No.: 13/069,804

(22) Filed: Mar. 23, 2011

(30) Foreign Application Priority Data
Mar. 31, 2010 (JP) 2010-083001

(51) Int. Cl. G11B 20/00

(52) U.S. Cl. 369/47.28; 369/47.15; G9B/20

(57) ABSTRACT

A digital disk device is provided in which the quality of a digital signal is improved without causing the development cost for and power consumption by the digital disk device to increase. An ADC included in a signal conversion circuit samples an analog signal which represents the intensity of a laser beam reflected, after being emitted from a laser source driven by a current superimposed with a high-frequency signal, from an optical disk using a clock signal whose frequency is substantially the same as that of the high-frequency signal and converts the sampled analog signal into a digital signal. An LPF provided in a stage preceding the ADC passes a component, not exceeding a predetermined frequency, of the analog signal with the frequency of the clock signal set to be higher than the predetermined frequency.

### CROSS-REFERENCE TO RELATED APPLICATIONS

The disclosure of Japanese Patent Application No. 2010-83001 filed on Mar. 31, 2010 including the specification, drawings and abstract is incorporated herein by reference in its entirety.

### BACKGROUND

1. Field of the Invention

The present invention relates to a signal conversion circuit and a sampling method therefor, and more particularly, to a technique suitable for use in reproducing information received from an optical disk.

2. Description of Related Art

Optical disk devices for playing optical disks such as compact disks (CDs), digital versatile disks (DVDs), and Blu-ray disks (BDs) are widely used.

Such optical disk devices employ a high-frequency superimposition method to inhibit noise caused, for example, by a laser beam reflected from an optical disk during reproduction operation (may hereinafter be referred to as “returned beam”) and interference noise resulting from variations in the oscillation frequency of the laser source caused by optical path differences and temperature changes. In a high-frequency superimposition method, a drive current superimposed with a high-frequency signal of about several hundred MHz to 1 GHz is supplied to a laser source to have a pulsed laser beam emitted from the laser source.

The beam returned from an optical disk is, roughly described, converted into an analog signal representing the beam intensity in a light receiving IC to be then converted into a digital signal in an analog-to-digital converter (ADC). To be concrete, the analog signal is subjected to band limiting processing at a low-pass filter (LPF) to have its component exceeding the Nyquist frequency removed for the purpose of inhibiting aliasing noise and is then sampled at a sampling frequency at the ADC. In the following description, the Nyquist frequency and the sampling frequency may be respectively denoted by “fn” and “fS.” According to the sampling theorem, the Nyquist frequency fn and the sampling frequency fS have a relationship expressed as “fS≧2fn.”

In recent years, however, with optical disk devices growing higher in operating speed, the signals reproduced by them have been growing wider in frequency range, making it unavoidable to raise the cut-off frequencies (may hereinafter be represented by symbol “fc”) of LPFs used to process the reproduced signals. Hence, as shown by an LPF output characteristic 501 in FIG. 4, a signal component (may hereinafter be referred to as a “residual superimposed high-frequency component”) 401 corresponding to a frequency fHF of the high-frequency signal (may hereinafter be referred to as the “frequency of the superimposed high-frequency signal”) in the frequency band above the Nyquist frequency fn of the analog signal is left without being adequately attenuated.

As a result, aliasing noise 402 attributable to the residual superimposed high-frequency component 401 is generated in a band b1 (may hereinafter be referred to as a “reproduced signal band”) lower than the cut-off frequency fc. For example, in cases where the cut-off frequency fc of a fourth LPF is 150 MHz, the frequency fHF of the superimposed high-frequency signal is 300 MHz, and the sampling frequency fS is 400 MHz, the level of the residual superimposed high-frequency component 401 is high causing the level of the aliasing noise 402 generated at a frequency fHF* of 100 MHz in the reproduced signal band b1 to be also high. Thus, the aliasing noise 402 causes quality degradation of the digital signal (i.e. degradation of the reproduction performance of the optical disk device).

An optical disk device dealing with the above problem is disclosed, for example, in Japanese patent laid-open No. 2009-187593. In the optical disk device, a digital filter is provided in a stage preceded by an ADC, and the frequency of a high-frequency signal to be superimposed is set to be higher than the Nyquist frequency and lower than the frequency equaling the sampling frequency less the passband width of the digital filter, so that aliasing noise attributable to the residual superimposed high-frequency component is generated in the passband of the digital filter.

### SUMMARY

Including a digital filter in an optical disk device according to the technique disclosed in Japanese patent laid-open No. 2009-187593, however, results in a higher development cost for and more power consumption by the optical disk device.

As another measure to deal with the foregoing problem, aliasing noise may be reduced by reducing the residual superimposed high-frequency component using a high-order LPF. It is, however, difficult to realize an LPF whose group delay characteristic in the passband is constant and whose cut-off characteristic outside the reproduced signal band is steep, and developing such an LPF will involve a large development cost.

It may also be considered to reduce aliasing noise by setting the frequency of a high-frequency signal to be superimposed to be adequately higher than the cut-off frequency so as to cause the residual superimposed high-frequency component to be adequately attenuated. Implementing such a measure will, however, increase the cost of developing a laser diode driving circuit required and will also cause electromagnetic interference (EMI).

Furthermore, it may also be considered to set a sampling frequency to be adequately higher than the frequency of a high-frequency signal to be superimposed while allowing the residual superimposed high-frequency component to be attenuated by a digital filter provided in a stage preceded by an ADC. Implementing such a measure, however, will increase, as in the case of the technology disclosed in Japanese patent laid-open No. 2009-187593, the development cost for and the power consumption by the optical disk device to be provided with a faster ADC and high-order digital filter.

The signal conversion circuit according to an aspect of the present invention includes a conversion section which samples an analog signal and converts the analog signal into a digital signal, the analog signal representing the intensity of a laser beam reflected, after being emitted from a laser source driven by a current superimposed with a high-frequency signal, from an optical disk. In the signal conversion circuit, the frequency of a clock signal used for sampling the analog signal is substantially the same as the frequency of the high-frequency signal.

In the sampling method according to an aspect of the present invention, an analog signal representing the intensity of a laser beam returned after being emitted from a laser source driven by a current superimposed with a high-frequency signal is sampled at a frequency substantially the same as the frequency of the high-frequency signal.

Namely, according to the present invention, it is possible to inhibit the generation of aliasing noise attributable to a residual superimposed high-frequency component by setting a sampling frequency and the frequency of a high-frequency signal to be superimposed to a same value.

According to the present invention, the quality of a digital signal can be improved for an optical disk device without causing the development cost for and power consumption by the optical disk device to increase.

### BRIEF DESCRIPTION OF THE DRAWINGS

FIG. 1 is a block diagram of an example configuration of the signal conversion circuit according to an embodiment of the present invention;

FIG. 2 is a graph showing an example of operation of the signal conversion circuit according to the embodiment;

FIG. 3 is a graph showing another example of operation of the signal conversion circuit according to the embodiment; and

FIG. 4 is a graph for describing a problem with a general optical disk device.

### DETAILED DESCRIPTION OF THE PREFERRED EMBODIMENT

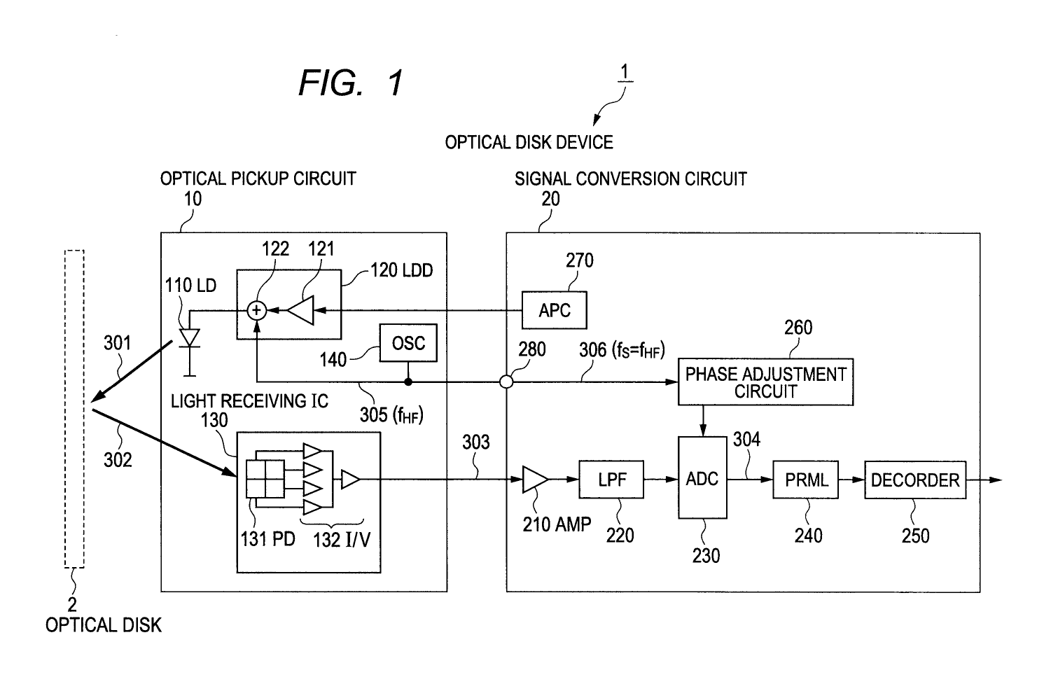

A signal conversion circuit according to an embodiment of the present invention and an optical disk device using the signal conversion circuit will be described below with reference to FIGS. 1 to 3. In the drawings, identical elements are denoted by identical reference numerals, and duplicate descriptions are omitted where appropriate for clarity.

As shown in FIG. 1, an optical disk device 1 according to an embodiment of the present invention includes an optical pickup circuit 10 and a signal conversion circuit 20. Broadly describing, the optical pickup circuit 10 emits a pulsed laser beam 301 to an optical disk 2, receives a returned beam 302 from the optical disk 2, and generates an analog signal 303 indicating the intensity of the returned beam 302. The signal conversion circuit 20 samples the analog signal 303 and converts it into a digital signal 304. Though not shown, the optical disk device 1 is, like general optical disk devices, provided with an optical system (including such optical elements as a lens, beam splitter, and diffraction grating) for emitting the laser beam 301 to the optical disk 2. In the stage following the signal conversion circuit 20, a processing circuit, such as a processor, for processing the digital signal 304 is provided.

To be in more detail, the optical pickup circuit 10 includes a laser diode (hereinafter referred to as an “LD”) 110, a laser diode driver (hereinafter referred to as an “LDD”) 120, a light receiving IC 130, and an oscillator (hereinafter referred to as an “OSC”) 140.

The LDD 120 includes an amplifier 121 and an adder 122. The amplifier 121 amplifies an input current. The adder 122 drives the LD 110 with a current obtained by superimposing a high-frequency signal 305 inputted from the OSC 140 on the output current from the amplifier 121 and thereby causes the LD 110 to emit a pulsed laser beam.

The light receiving IC 130 includes a photodetector (hereinafter referred to as an “PD”) 131 and a current/voltage converter (hereinafter referred to as an “I/V”) 132. The PD 131 generates a current corresponding to the intensity of the returned beam 302. The I/V 132 converts the output current from the PD 131 into a voltage signal and outputs the voltage signal, as an analog signal 303, to the signal conversion circuit 20.

The signal conversion circuit 20 includes an amplifier (hereinafter referred to as an “AMP”) 210, an LPF 220, an ADC 230, a partial response maximum likelihood (PRML) circuit 240, a decoder 250, a phase adjustment circuit 260, and an auto power control (APC) circuit 270.

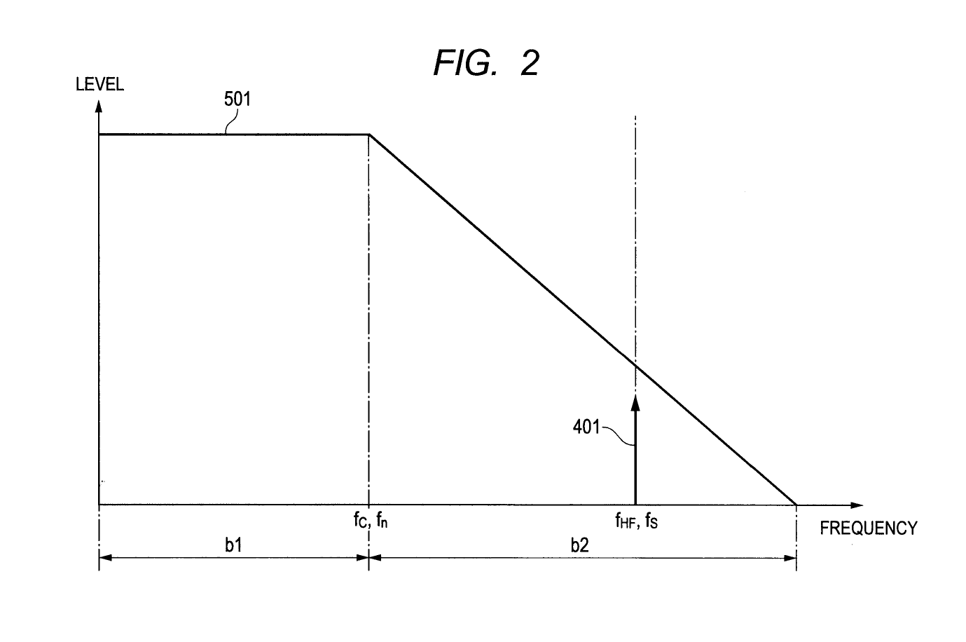

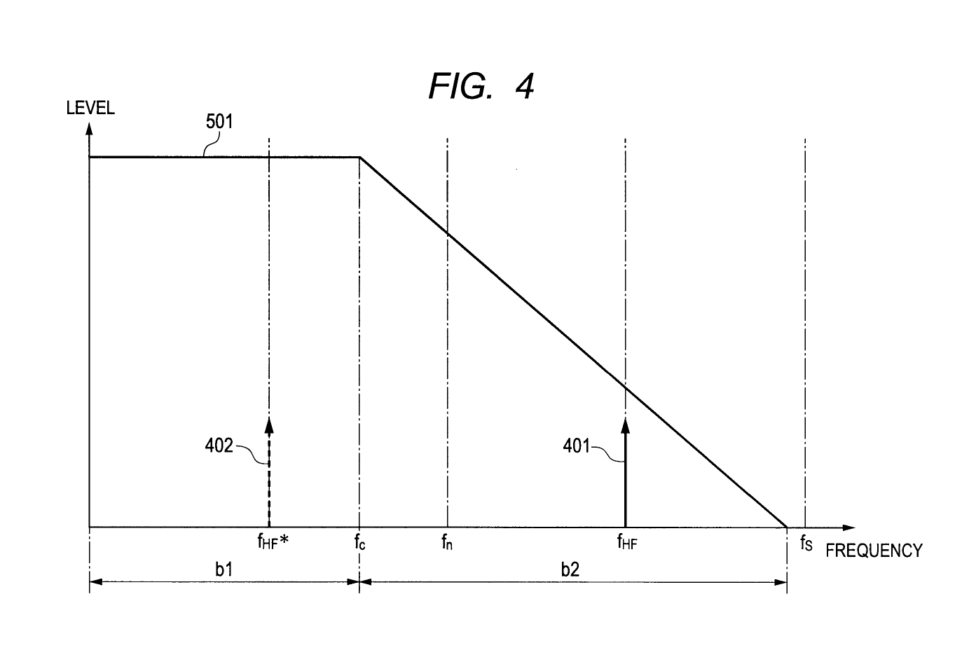

The LPF 220 passes a band component not exceeding a predetermined frequency of the analog signal 303 amplified by the AMP 210. The band component not exceeding the predetermined frequency includes, as shown by an output characteristic 501 of the LPF 220 in FIG. 2, a reproduced signal band b1 not exceeding a cut-off frequency fc and an attenuated band b2 attenuated by the LPF 220. Namely, the LPF 220 has an output characteristic similar to the output characteristic (see FIG. 4) of those low-pass filters used in general optical disk devices.

The ADC 230 samples, using a sampling clock signal 306 inputted from the OSC 140 via a terminal 280, the analog signal 303 band-limited by the LPF 220. The sampling clock signal 306 and the high-frequency signal 305 are two signals branched from a same signal outputted from the OSC 140, so that sampling frequency fS equals the frequency of a high-frequency signal to be superimposed fHF. The sampling clock signal 306 is suitable for supply to the ADC 230 by differential transmission. The sampling clock signal 306 may alternatively be generated by a local oscillator provided inside the signal conversion circuit 20 as long as its frequency fS equals the frequency fHF of the high-frequency signal to be superimposed. Instead of the OSC 140, the local oscillator may be shared by the ADC 230 and the LDD 120. Compared with a case in which both the OSC 140 and the local oscillator are included in the optical disk device 1, the development cost will be reduced when the optical disk device is configured as shown in FIG. 1 possibly with the OSC 140 replaced by the local oscillator for shared use as described above.

The PRML circuit 240 includes, for example, a partial response (PR) equalizer and a Viterbi decoder, and processes the digital signal 304 outputted from the ADC 230 for equalization and maximum-likelihood decoding. The decoder 250 demodulates the digital signal 304 having undergone equalization and maximum-likelihood decoding by the PRML circuit 240, then outputs the demodulated signal to a subsequent processing circuit.

The phase adjustment circuit 260 adjusts the phase of the sampling clock signal 306 to make it match the input phase of the analog signal 303 inputted to the ADC 230. The phase adjustment circuit 260 may have a simple configuration including, for example, a delay element such as a buffer. The delay element to be used is required to be preset for a delay determined, for example, according to the optical path lengths for the laser beam 301 and returned beam 302, the processing time required for the light receiving IC 130, AMP 210, and LPF 220, and the transmission path length for the analog signal 303. Or, the phase adjustment circuit 260 adjusts the phase of the sampling clock signal 306 so as to make the value of the digital signal 304 outputted from the ADC 230 appropriate (or, to be concrete, so as to cause the analog signal 303 to be sampled approximately at its maximum value to thereby achieve a high signal-to-noise ratio (SNR)).

The APC circuit 270 controls the LDD 120 to stabilize the output of the LD 110.

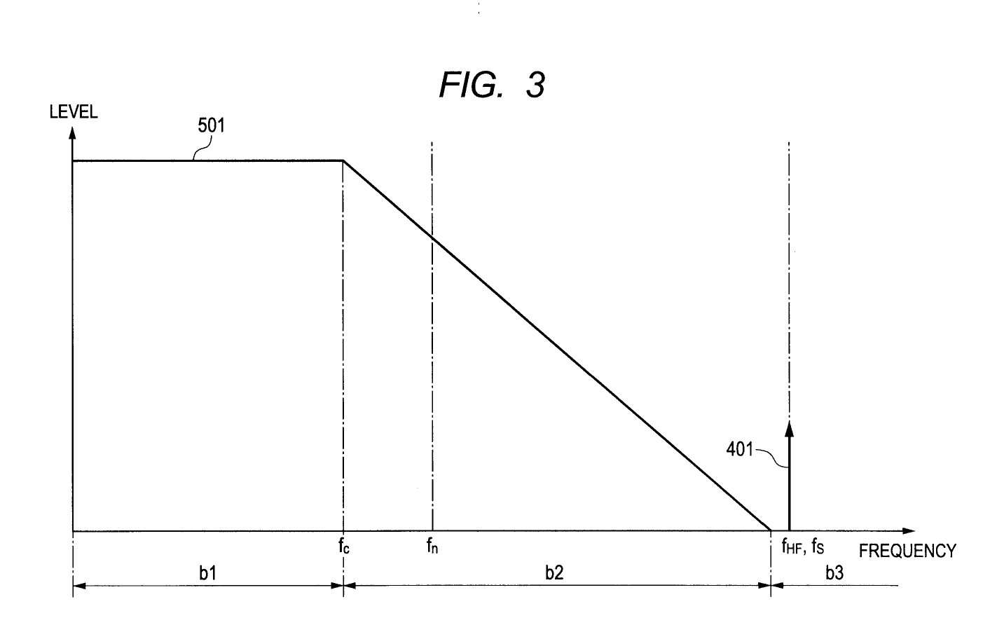

Example operations of the signal conversion circuit 20 will be described below with reference to FIGS. 2 and 3. Note that the operation of the optical pickup circuit 10 will not be described as the operation is similar to that of corresponding circuits included in general optical devices.

When the sampling frequency fS and the frequency fHF of the high-frequency signal to be superimposed are set to a same value, the analog signal 303 (attenuated band b2) band-limited by the LPF 220 contains, as shown in FIG. 2, a residual superimposed high-frequency component 401. In this case, however, no aliasing noise attributable to the residual superimposed high-frequency component is generated in the reproduced-signal band b1.

The ADC 230 can therefore sample the analog signal 303 without being affected by any aliasing noise, so that the quality of the digital signal 304 can be largely improved compared with cases where general optical disk devices are used.

When, as shown in FIG. 3, the sampling frequency fS and the frequency fHF of the high-frequency signal to be superimposed are set to be higher than the upper-limit frequency of the attenuated band b2 (i.e. to an optional frequency in a cut-off band b3 of the LPF 220), the reproduced-signal band b1 and attenuated band b2 contain no residual superimposed high-frequency component 401.

The quality of the digital signal 304 can therefore be further improved.

The present invention is not limited to the above embodiment, but various changes can be made therein by one skilled in the art within the spirit and scope of the appended claims of the invention.

For example, the present invention can be applied not only to an optical disk device but also to various systems for having an output laser beam which has been oscillated using a high-frequency superimposition method re-inputted (e.g. having the beam looped back). Also, even in cases where a self-oscillating laser source which oscillates in multiple modes is used, the same effects as those described above can be obtained by setting the oscillation frequency of the laser source and the sampling frequency to a same value.

What is claimed is:

1. A signal conversion circuit comprising a conversion section which samples an analog signal and converts the analog signal into a digital signal, the analog signal representing the intensity of a laser beam reflected, after being emitted from a laser source driven by a current superimposed with a high-frequency signal, from an optical disk,
wherein the frequency of a clock signal used for sampling the analog signal is substantially the same as the frequency of the high-frequency signal.

2. The signal conversion circuit according to claim 1, further comprising a band limiting section which is provided in a stage preceding the conversion section and which passes a component, not exceeding a predetermined frequency, of the analog signal,
wherein the frequency of the clock signal is higher than the predetermined frequency.

3. The signal conversion circuit according to claim 1, wherein the clock signal is supplied from an oscillator oscillating the high-frequency signal.

4. The signal conversion circuit according to claim 3, further comprising an adjustment section which adjusts the phase of the clock signal to make the phase of the clock signal match the input phase of the analog signal inputted to the conversion section.

5. A sampling method in which an analog signal representing the intensity of a laser beam returned after being emitted from a laser source driven by a current superimposed with a high-frequency signal is sampled at a frequency substantially the same as the frequency of the high-frequency signal.

6. The sampling method according to claim 5, wherein, before the sampling is performed, a band component lower in frequency than the frequency substantially the same as the frequency of the high-frequency signal is extracted from the analog signal.
